(19) United States
(12) Patent Application Publication
(10) Pub. No.: US 2008/0046312 A1
(43) Pub. Date: Feb. 21, 2008

(54) METHOD AND SYSTEM FOR TARGET MARKETING OVER THE INTERNET AND INTERACTIVE TV

(76) Inventors: Ehud Shany, Irvine, CA (US); James R. Schoenfield, Malibu, CA (US); Randy Ripley, Venice, CA (US)

Correspondence Address: CHARLES C.H. WU, 98 DISCOVERY, IRVINE, CA, 92618-3105, US

(21) Appl. No.: 11/464,789

(22) Filed: Aug. 15, 2006

(51) Int. Cl. G06Q 30/00

(52) U.S. Cl. 705/14

(57) ABSTRACT

A method and system for target marketing and/or advertisement for search engine providers and advertisers which is based on a user profile. The user profile is constructed from a combination of public data, propriety data and user's data. The user's data is provided by the user (direct collection) or by data which is associated with the user (indirect collection). Optional monetary contribution to an Organization of Choice (e.g. church, school, etc.), or rebate of a percentage of advertising revenue to the user is utilized to incentive participation. User ID, timer and counters are used to prevent multiple identical clicks-through on hyperlinks.

### BACKGROUND OF THE INVENTION

1. Field of the Invention

The present invention relates to computer-based Internet web-enabled or interactive TV methods and systems for target marketing and advertisement. More particularly it is related to methods and apparatus, by which search-engine service providers and/or advertisers utilize a user profile in order to send the user targeted results or targeted advertisement segments and to eliminate multiple hyperlinks click.

2. Background

The transfer of information over computer networks has become an increasingly important means by which institutions, corporations, and individuals do business. Currently, the largest computer network in existence is the Internet. The Internet is a worldwide interconnection of computer networks that communicate using a common protocol. These computers are being used for a variety of applications in which interactive TV is one example.

The Internet has emerged as a large community of electronically connected users located around the world who readily and regularly exchange significant amounts of information. In addition, the Internet has evolved to serve as the most common search engine and advertisement media. In particular, the Internet is rapidly transforming into a global search machine and advertisement distribution channel. This transformation of the Internet into a global marketplace was driven in large part by the introduction of an information system known as the World Wide Web (“the web”). The web is a unique distributed database designed to give wide access to a large volume of documents. The database records of the web are in the form of documents known as “pages”. These pages reside on web servers and are accessible via the Internet. The web, therefore, is a gigantic database of information dispersed across countless individual computer systems that is constantly changing and has no recognizable organization or morphology. Computers connected to the Internet may access the web pages via a program known as a “browser”, which typically has a powerful, simple-to-learn graphical user interface. One technique supported by the web browser is known as “hyperlinking”, which permits web page authors to create links to other web pages which users then can retrieve by using simple point-and-click commands on the web browser.

The web pages may be constructed in any one of a variety of formatting conventions, such as Hyper Text Markup Language (“HTML”). Any person with a computer and a connection to the Internet may access any publicly accessible page posted on the web. Thus, a presence on the web has the capability to introduce a worldwide base of consumers to businesses, individuals, and institutions seeking to advertise their products and services to potential customers.

Furthermore, the ever increasing sophistication of search engines makes the web an increasingly attractive medium for advertising and other business purposes. However, the web is composed of a seemingly limitless number of web pages dispersed across millions of different computer systems all over the world, in no discernible organization. Mechanisms, such as directories and search engines, have been developed to index and search the information available on the web and thereby help Internet users locate their information of interest. These search engine services enable consumers to search the Internet for a listing of web sites, also known as URL (Uniform Resource Locators), based on a specific topic, product, or service of interest. Search services/engines are, after e-mail, the most frequently used tool on the Internet. As a result, web sites providing search services have offered advertisers access into the Internet's user community and have given advertisers the opportunity to target consumer interests based on keyword or topical search requests.

In a web-based search, on an Internet search engine, a user enters a search term comprising one or more keywords, which the search engine then uses to generate, in real time, a listing of web pages that the user may access via hyperlinks. The automated search technology that drives many search engines relies in large part on complex, mathematics-based database search algorithms that select and rank web pages based on multiple criteria, such as keyword density and keyword location. The search results generated by such mechanisms often may appear to be random and even irrelevant. Moreover, as the volume and diversity of Internet content has grown, on many popular web search sites, consumers frequently must click through multiple branches of a hierarchical directory to locate web sites responsive to their search request, a process that is slow and unwieldy from the consumer's standpoint. Thus, the prior art search engines are ineffective for web page owners seeking to target their web exposure and distribute information to the attention of specific interested users.

Furthermore, current models for generating web site traffic, such as Sponsored Links and/or Advertising Segments (e.g. banners, video clips, animation, and text), follow traditional advertising models and fail to utilize the unique attributes of the Internet. In this advertising model, web site promoters often purchase a location in the Sponsored Links or a space on the pages of popular commercial web sites. The Sponsored Links and Advertising Segments may act as hyperlinks which a visitor may click on to access a site. Like traditional advertising, Sponsored Links advertising and Advertising Segments advertising on the Internet typically are priced on an impression basis with advertisers paying for exposures to potential consumers. Sponsored Links and Advertising Segments may be targeted to search terms. Nonetheless, impression-based advertising inefficiently exploits the Internet's direct marketing potential, as the click-through rate, the rate of consumer visits a Sponsored Links or Advertising Segments generates to the destination site, may be quite low. Web site promoters therefore are paying for exposure to many consumers who are not interested in the product or service being promoted, as most visitors to a web site seek specific information and may not be interested in the information announced in the Sponsored Links or Advertising Segments engine results.

The main drawback of the current search engine related advertisement method is based on the fact that regardless of the profile of the user conducting the search, the results are always the same. In other words, two users with two different profiles will get the same results at a given time with a given search engine. Additionally and equally important, today Sponsored Links and Advertising Segments can not prevent a user from clicking several times on their hyperlinks, thus forcing the advertiser to pay for multiple clicks from a single user. Internet based advertisement which is not related to search engine mechanism has the same drawbacks.

For clarification purpose only and without limiting the current innovation, a user profile refers to a collection of data which is based on processes such as statistical functions and mathematical algorithms and data such as demographic data, geographic data, socioeconomic data, age and gender.

### SUMMARY OF THE INVENTION

The present invention provides a method and system for a target marketing mechanism which is related to search engine results and/or advertisement segments over the internet and/or interactive TV. As part of the innovation, search engine providers and/or advertisers can display their search results via Sponsored Links and/or Advertisement Segments (e.g. Banners, Video Clip) based on a particular group or individual profile of the user conducting the search or surfing the Internet. For each user, advertisements and/or search results are tailored to match his/her profile; thus, two different users will get two different Sponsored Links/Advertisement Segments even though they may use the same keywords/topics or surf the Internet at the same time.

Under the current innovation, the profile of the user is constructed from a dynamic database which is constantly updated and restructured under processes such as mathematical algorithms and statistical functions. As part of this process, the user may provide data, such as zip-code, age-group, and gender. This data may be provided directly/indirectly by the user or indirectly by him selecting an Organization of Choice (e.g. Church, University, etc.). In exchange, the search engine provider and/or advertiser donates a portion of its advertising related income to said organization. Alternatively, the user may himself/herself receive all or a portion of the compensation.

Public, private and/or proprietary databases related to users and organizations are searched, researched, categorized, and processed on an ongoing basis. Cross references between the user and said databases enrich and improve the user profile.

Duplication of identical hyperlink clicks is avoided by a unique user identification associated with each user, timer(s) and counter(s).

### BRIEF DESCRIPTION OF THE DRAWINGS

FIG. 1 illustrates a typical screen by which the search results are being displayed alongside the advertisement section (Sponsored Links section).

FIG. 2 illustrates an organization site which uses an HTML software code in order to utilize a popular search engine such as Google as part of the site URL.

FIG. 3 describes a flowchart which represents the user selection of Organization of Choice. This selection is used for improving the user profile.

FIG. 4 describes a flowchart which represents the process by which the user provides data which is being used for structuring and improving his/her profile.

FIGS. 5-A and 5-B serve as an example of publicly available data which exists and can be accessed over the Internet. The example covers statistics about the population of the city of Irvine in CA, USA and High School in this city.

FIG. 6 serves as an example of advertisement segment under the “home” page of www.yahoo.com

FIG. 7 describes a flowchart which represents a counting method of the user's click-through on hyperlinks.

### DETAILED DESCRIPTION OF THE INVENTION

Methods and apparatus, by which search-engine service providers and/or advertisers utilize a user profile in order to send the user targeted results or targeted advertisement segments and in order to eliminate multiple identical hyperlinks clicks, are disclosed.

In the following description, for purposes of explanation and not limitation, specific details are set forth in order to provide a thorough understanding of the present invention. However, it will be apparent to one skilled in the art that the present invention may be practiced in other embodiments that depart from these specific details. In other instances, detailed descriptions of well-known methods and devices are omitted so as to not obscure the description of the present invention with unnecessary detail.

The main deficiency of present Internet related Sponsored Links 103 and Advertisement Segments 601 is in the fact that regardless of the profile of the user, the results are always the same. In other words, two different users with two different profiles (such as socioeconomic, geographic and/or other demographic data, age and gender) will obtain the same results at a given time with a given search-engine. The same deficiency exists with the delivery of Advertisement Segments 601 to users who surf the Internet.

Additionally, if a user clicks several times (multi-click) on the same hyperlink associated with Sponsored Links and/or Advertisement Segments, the advertiser typically is charged per click, and not just for the intent clicks. Since advertisers generally are charged for each click-through referral generated via the hyperlinks of the Sponsored Links and/or Advertisement Segments, advertisers have an incentive to send their advertisement only to the consumer profile or profiles they are targeting. Accordingly, there is a need for an improved method and apparatus for generating Sponsored Links and Advertisement Segments that can improve the efficiency of delivery of advertisements and/or other content to the targeted users/consumers while maximizing the revenue for the search engine providers/advertisers, as well as improving the click-through rates.

One skilled in the art will recognize that there are many ways by which the Advertisement Segments are being displayed on a browser or interactive TV. For clarification purpose only, and without limiting the current innovation, Advertisement Segments refers to video clips, banners, text, animation, rolling/scrolling pictures, etc.

Under the current innovation, search engine providers and advertisers, as well as other entities, are able to control the content of the Sponsored Links and Advertisement Segments so that the displayed content matches the profile of the user who conducts the search or surfs the web.

Additionally the current innovation delivers relevant search results to consumers while providing Internet advertisers and promoters with a cost-effective way to target consumers likely to be interested in particular products and services.

Today, the most common ways for distributing Internet related advertisements are: (a) Sponsored Links 103 (b) Advertisement Segments 601.

Generally speaking, search engines providers (e.g. www.Google.com, www.yahoo.com, etc.) provide search results of two types: (a) results 102, which are initiated by a search string/topic 101 and based on the search engine algorithms and a search criteria, and (b) advertisement sections, known as Sponsored Links, in which the displayed results 103, are based on algorithms and a search criteria BUT also are based on other parameters, such as a payments/bid apparatus which promotes companies, products and services. The second type serves as the main source of income for search engine providers. In most cases the entity which is linked to a Sponsored Link pays the search engine provider based upon agreed criteria, such as the number of clicks-through on the Sponsored Link.

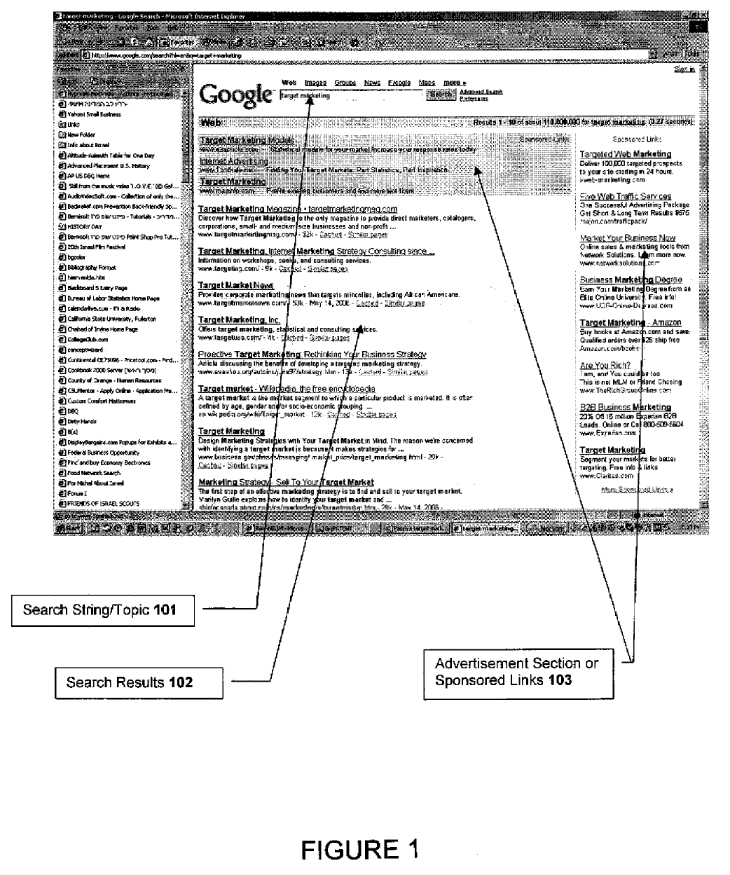

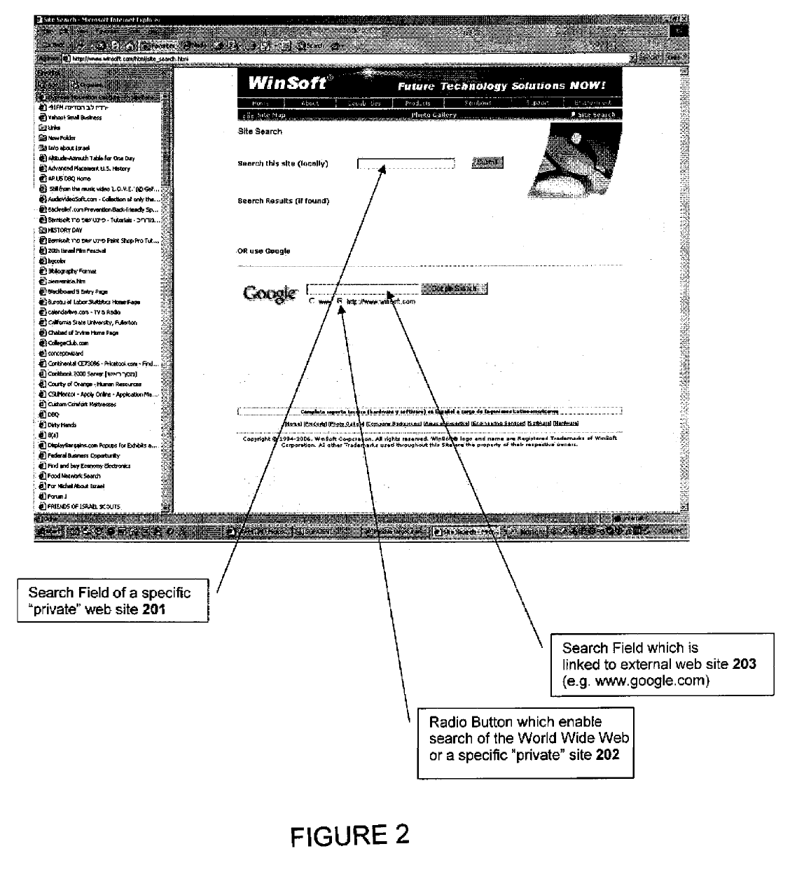

Two common methods by which a search engine is used are: (a) the user types a topic/search term in the available field 101 incorporated as a part of the search engine provider's URL (FIG. 1, for clarification purpose, illustrates the URL of www.google.com and its search engine screen) and (b) the user types a topic/search term 203 in a URL which has a link to the search engine provider. FIG. 2 illustrates a URL which has an embedded HTML software code which provides a link to Google's search engine.

Some search engine providers (such as Google) provide HTML software code (or other software code such as XML and Java) which enables a URL to perform a global search over the entire web or to search the local URL domain only 202. The search field 203, although appearing in a URL other then the search engine provider's URL, is linked to and delivers the same results as said URL in FIG. 1 (in this example the Google search engine).

Both Sponsored Links and Advertising Segments typically have embedded hyperlinks, which enable the user to click on them, and which in turn results in the display of a new page/URL associated with said hyperlink.

The current innovation utilizes a user profile as part of its target marketing method. For clarification purpose only, and without limiting the current innovation, a user profile is constructed from users' data, public, a private data and/or proprietary data. The users' data is provided by the users (direct and indirect collection) or by data which is associated with the user (indirect collection). Public, private and proprietary data is collected from any source which can enrich and improve the user profile. One skilled in the art will recognize that there are many ways by which public and/or proprietary data can be obtained and processed. For clarification purpose only and without limiting the current innovation, public data is data which is available from open public sources such as the internet. Proprietary data is data which is obtained through payment and/or subscription, such as credit-card related data.

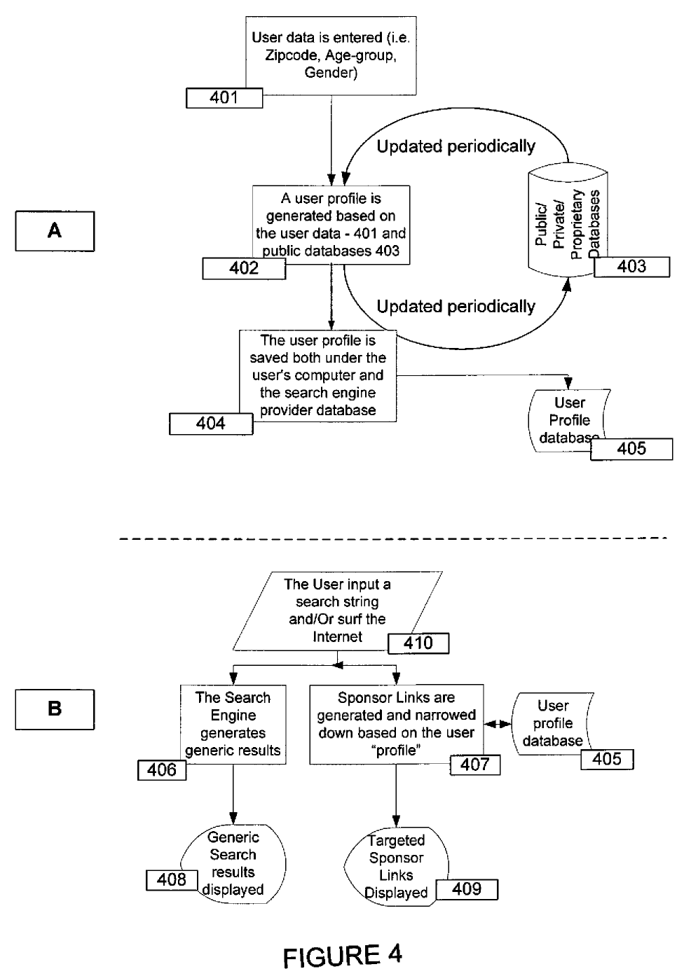

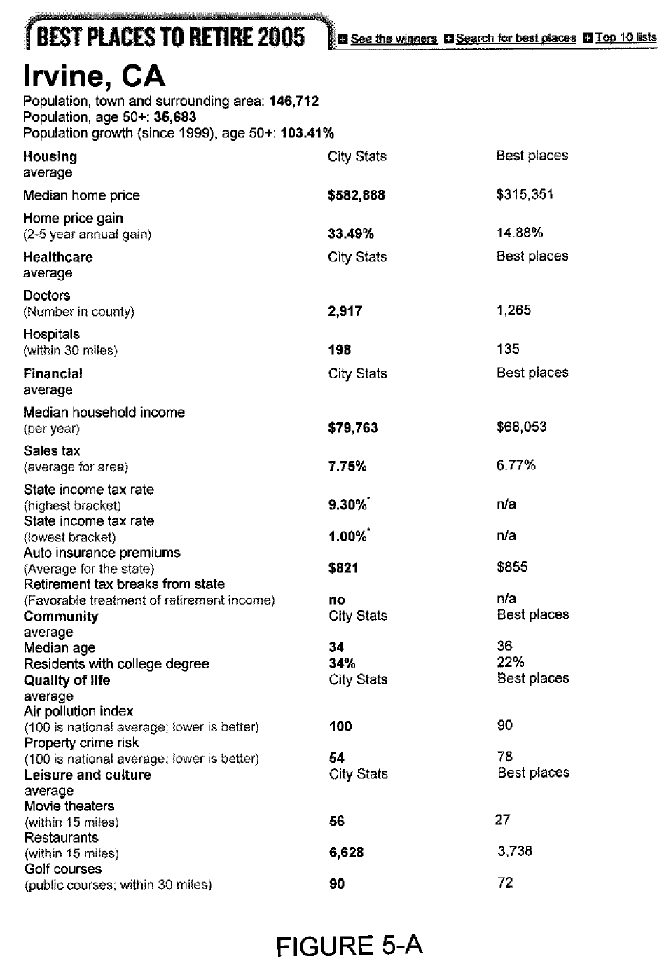

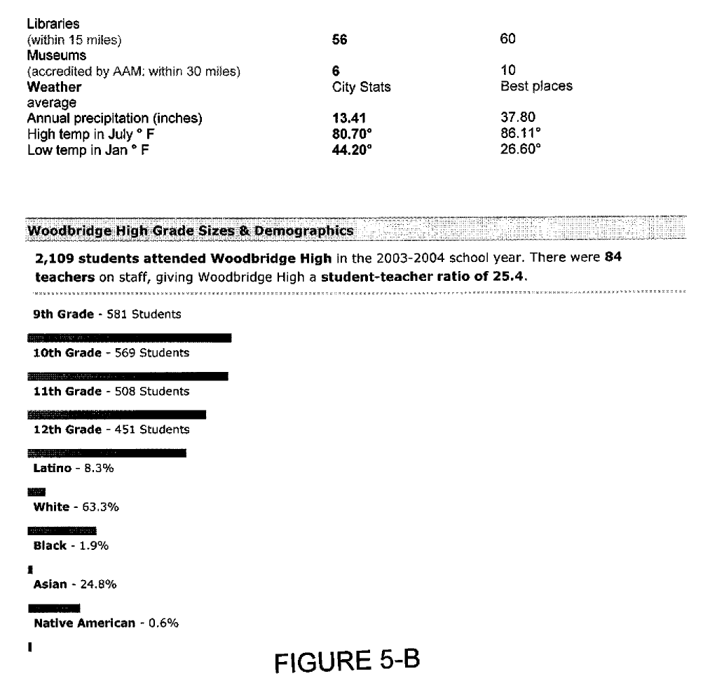

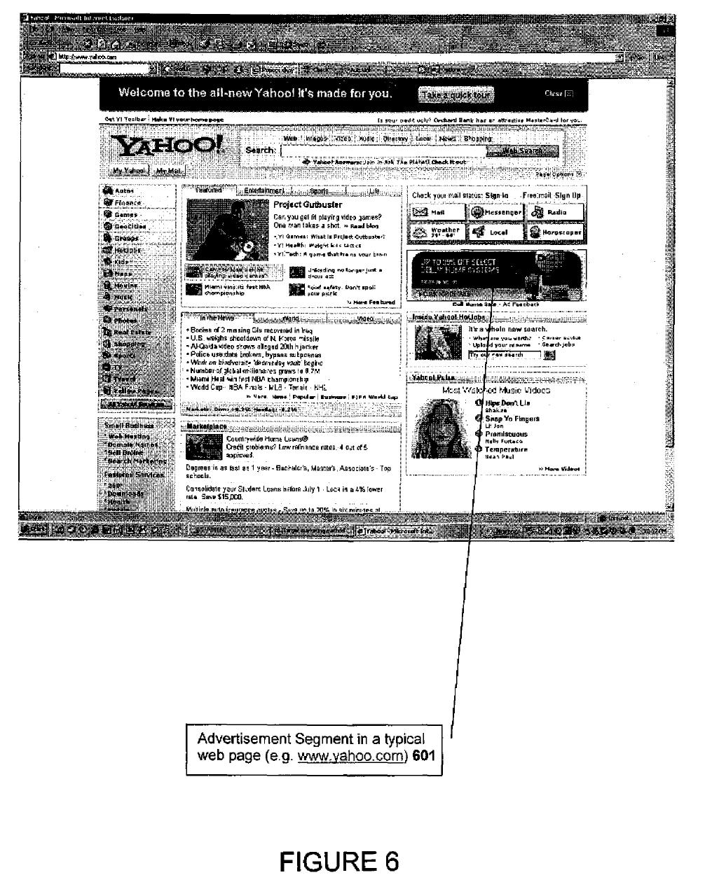

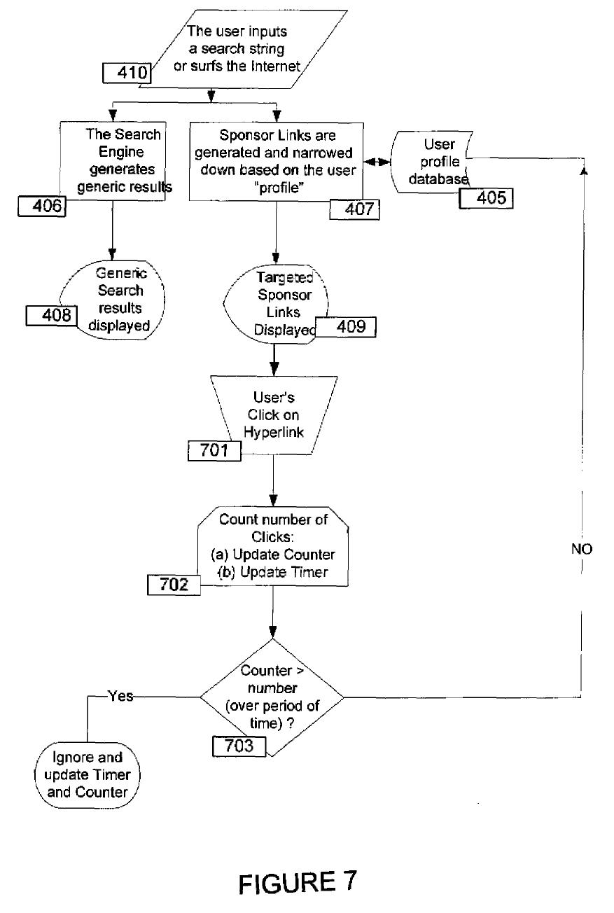

FIG. 4 illustrates a process by which a user provides “direct” or “indirect” data to the search engine provider and/or advertiser. Using the “direct” method, a search engine provider (and/or advertiser) asks the user to enter data 401 which will be used for the construction of the user profile. An optional extension of this method and system may compensate those users who provide data which can be used for enrichment and improvement of the user profile. This data includes but is not limited to zip-code, age, gender and income. Based on this data and a cross references to publicly available and proprietary data/databases 403 and FIG. 5, a user profile is being generated 402. For clarity purpose, process 402, which processes the data, will be described later on. Using the “indirect” method, the search engine (or advertiser related computer program) retrieves data from the user computer. This data may be available from “cookies”, bookmarks or other traces. For clarification purpose only, and without limiting the current innovation, zip-codes, which are widely used by Internet applications, such as instant weather reports, local activity reports, etc., can be obtained. In this illustration the zip-code (or other data) is used to begin and/or initiate the construction of a user profile, which then can be enriched from other data sources (IP address, browser version, city, state, country of origin, internet service provider, computer operating system, etc.).

Once a user profile is generated, it is saved 404 on both the user computer and the search engine database 405 of users-profiles. One skilled in the art will recognize that there are many ways by which the user profile can be saved. One example, and without limiting the current innovation, is to save an index-key on the user computer which can be used as a pointer to a data structure which is located at the search engine provider (and/or advertiser) database 405.

Under the current innovation, a user profile is a collection of processed data such as demographic data, geographic data and socioeconomic data. This includes but is not limited to age, gender, geography, ethnicity, average income, etc.

FIG. 4, Section A, illustrates one of the methods by which a user profile can be generated. Under FIG. 4, Section B, the user profile is being used for Target Marketing. As the user searches (or surfs) the internet and inputs the “search string” 410, the search engine retrieves the user profile from the user profile database 405 and generate the Sponsor Links which are based on this user profile 407. Generic results are displayed as of today 406, 408 and 102. The Targeted Sponsor Links are displayed 409 based on the user profile so that two different users will obtain two different sets of Sponsor Links, based on the user profile. Under FIG. 4, Section B, Internet surfing activity generates a similarly targeted and focused result as relates to Advertisement Segments. In such case, the current innovation displays Targeted Advertisement Segments 407 and 409 rather than Sponsor Links

Under process 402, public, private and propriety records are being analyzed as part of the user profile structuring processes. FIGS. 5-A and 5-B were taken from www.CNNmoney.com. In this example, by knowing the user's zip-code, a median household income is easily obtainable. Example of other data which can be assembled by use of zip code include, average age, weather statistics, insurance rates, crime rates, ethnic makeup, family size, as well as other information useful in assembling user profiles.

In the case where the user provides additional data, for example, gender or age, a “better” profile is built. Process 402 uses analysis tools and statistic methods which vary and are out of the scope of this innovation. For clarification purpose only and without limiting the current innovation, the following example is illustrative. A kitchen designer/contractor located on the US East Coast is targeting consumers around New York City and Boston with a median household income of $60,000 and a median home price of $300,000. If a user searches the topic “Kitchen Design” 410, the results of the search engine will be displayed as it is done today 406 and 408. The Sponsored Links though, will be adjusted based on each user profile. User profiles that match the advertiser's criteria(s) are retrieved from the user profile database 405. As part of process 402, which uses at a minimum, the user's zip code, logical-statistical-mathematical processes acquire the user profiles that match the zip-code for the New York City and Boston areas, and the public, private and/or proprietary data available in regards to median home price and median household income in those locals. In the example above, two different users, one from Los Angeles, and the other from New York City, obtain two different sets of Sponsored Links, even though they search the same topic with the same search engine at the same time. Different users who surf the Internet likewise would obtain tailored results, and based on their profiles likely would obtain different Advertisement Segments.

It is important to mention that the process of building the user profile is dynamic and could be updated periodically, based on established parameters such as a user's age, which under the current innovation would be tracked and re-calculated automatically over time, and/or public and proprietary data as it becomes available and evolves. This dynamic enrichment and evolution is an ongoing process regardless of the user's Internet surfing and search activities.

As was mentioned earlier, process 404 saves the user profile in the user's computer and the search engine provider's (or advertiser's) database. As an option, an index-key or pointer, counters and timers also are saved. The current innovation utilizes a counter and timer 702 which counts the number of user's clicks 701 per hyperlink per period of time. If the counter value is greater than a predefined value, the extra clicks are ignored and the timer and counter are reset. This data is fed back to the user profile database 405 for optional tagging of users who misuse the hyperlinks. In this case, the pointer or index-key serves as the user identification number (“user ID”). As a result of this method, the current innovation, by counting the number of clicks over a period of time, can filter out multiple clicks.

Additionally, under the current innovation and part of process 402, a set of user profiles is being adjusted based on the number of Sponsor Links' clicks over a period of time. This innovative method enables advertisers to test and fine-tune different user profiles based on the response (e.g. number of Sponsor Links' clicks) collected over a period of time.

The method described in the previous paragraphs is known as “active” method. Under the “active” method the user provides data “directly” or “indirectly”. This data is used for constructing his/her profile.

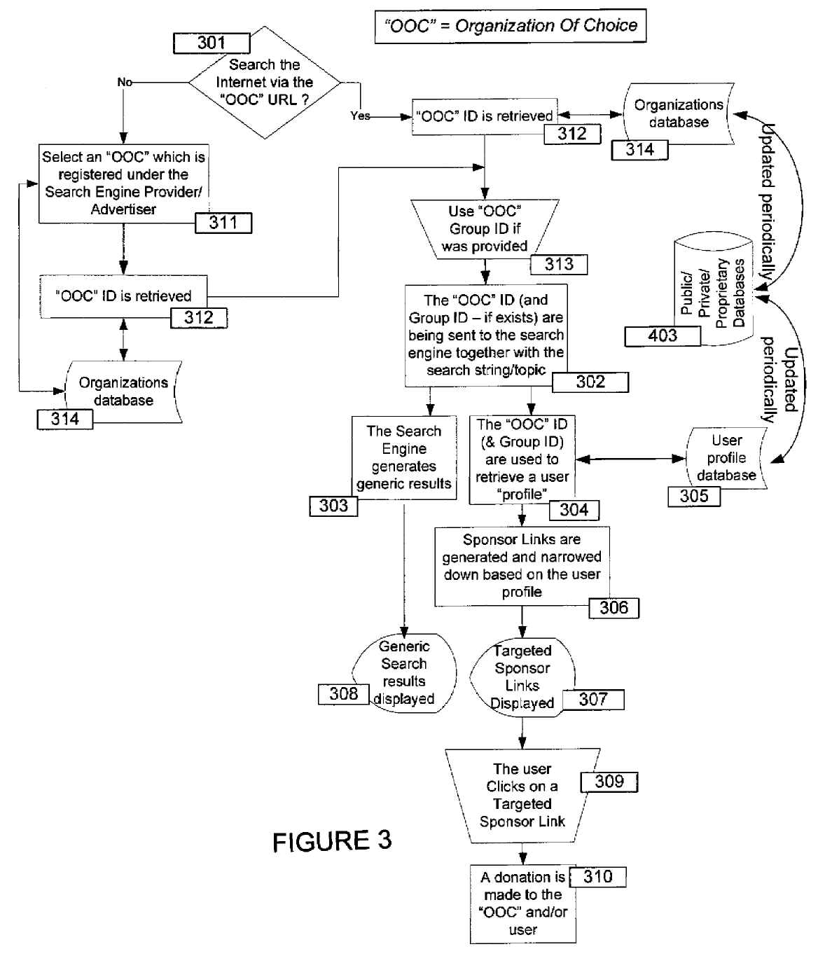

The following paragraphs describe the “passive” method as it is related to the current innovation. Under the “passive” method the user selects an Organization of Choice (e.g. school, church, hospital or other affinity group) to which the search engine provider and/or advertiser may contribute a portion of the advertisement revenue or other funding generated by the users activities—FIG. 3. Data which is associated with the Organization of Choice (zip-code, type, etc.) is linked to the user in order to construct and/or improve the user profile. For example, statistical and/or mathematical processes can analyze and improve a user profile based on the geographic location of the organization chosen, as well as other information related to the organization type or category.

Under the current innovation the user can select the Organization of Choice in two ways: (a) Selection of the organization's URL as the default user's search engine 301 and FIG. 2 or (b) Selection of the organization from a list which is provided by the search engine provider and/or advertiser 311 and 314. One skilled in the art will appreciate that variations of these selection methods may be in use without limiting the scope of the current innovation.

An organization needs to be register with the search engine provider and/or advertiser in order for it to be able to receive funds. During the registration process the organization is assigned a unique identification number (“organization ID”). This registration is done in two ways: (a) by the organization adding itself to the search engine provider list/database of registered organizations 314 or (b) by adding the search engine provider software program (HTML or alike) to the organization URL as illustrated in FIG. 2. The software code is set in such a way that the organization's ID is transmitted by said software code as a result of the user using this software code.

The data which the organization needs to provide, at a minimum, includes but is not limited to its address (state, city, zip-code), type (school, hospital, club) and name. Additional information, if provided, creates greater specificity and refinement of the user profiles related to that organization.

Once selected by the user, the Organization of Choice's ID is retrieved 312 from the organization database 314. In both ways (“a” and “b” above) the Organization of Choice's ID is sent to the search engine provider together with the search string/topic 302.

Furthermore, under the current innovation and in order to maximize the segmentation of different users, the organization is encouraged to provide a “Group-ID” 313 such as “adult-ID”, “student-ID” or “organization's chapter ID”. The search engine provider and/or advertiser may compensate the organizations that provide such a Group-ID, by paying them at a higher level of funding than those that do not provide segmentation data.

For clarification purpose only and without limiting the current innovation, under this method a parent and/or adult may obtain Group-ID “A”, a student may obtain Group-ID “B”, and elementary/middle school student a Group-ID “C”. Furthermore, large and/or geographically dispersed organizations such as the American Red Cross, may provide a Group-ID per chapter or other segmenting basis. By using this code 313, while being motivated to provide funding to the Organization of Choice, the user passively provides data which enriches the user profile. Again, this data is the Organization of Choice data, which is associated with the user.

Under process 304 the Organization of Choice ID and potential Group-ID are used to retrieve the user profile from the user profile database 305.

As part of the innovation, the search engine provider and/or advertiser periodically updates a user profile associated with each organization from relevant public, private and proprietary databases FIG. 3, 403.

Once the user profile is sent to the search engine 304 together with the search string/topic from process 302, the search engine provider generates the search results 303, but the Sponsor Links 306 are generated based on the user profile. The generic search results are displayed 308 as it is done today, but for each user a different set of Sponsor Links are displayed 307 based on the user profile.

If the user clicks on one of the Sponsor Links 309 a donation is made to his Organization of Choice 310 utilizing the Organization ID. This method and system encourages the users to use the Organization of Choice mechanism as part of their search method. From the advertiser's perspective, the Sponsor Link is targeted and tailored for each user.

For clarification purposes only and without limiting the current innovation, by way of example only, we assume that a manufacturer of golf clubs and golf related products targets adult customers with annual household income greater than $70,000, living within 30 miles of at least 20 golf courses. We also assume a private middle school in suburban California is enrolled as an “Organization of Choice”. We also assume that the school provided a Group-ID to the parents and another Group-ID to the students. One of the parents searches the term “golf products”, utilizing the school URL. The organization ID and Group ID are used to retrieve the user profile in real-time. The Sponsored Links which are displayed to the parent may or may not include the manufacturer of the golf clubs and golf related products, based on the manufacturer's requirements (adult with household income of at least $70K and having 20 or more golf courses within 30 miles) which are compared against the user profile. Assuming that this parent matches the requirements, the Sponsor Links would display the above manufacturer's hyperlink; if the parent clicks on this hyperlink, a contribution would be made to the school (the user's Organization of Choice).

Under the current innovation the Group-ID can be used in order to differentiate among multiple users of a single computer. Login mechanisms (such as “user name” and “password”) also can be utilized to differentiate among multiple users of the same computer.

One skilled in the art will appreciate that the system and method of the present invention can be used in various search environments and advertisement segments, such as searching music, pictures, news and maps. Additionally although the Organization of Choice mechanism was described as part of a search process, it also can be used for regular Internet surfing activity. Furthermore the combination of “Active” (direct and indirect) and “Passive” modes can be combined in order to enrich and improve the user profile. Additionally it can be used and implemented in an environment other than the Internet, such as Interactive TV.

What is claimed is:

1. A method for providing targeted content to a client from a server, the targeted content having at least a component provided by a format that a mechanism comprised by a transmission path from the server to the client is adapted to the target, the method comprising at least one of (a) providing the client with targeted results based on user's profiles whereby Sponsored Link is created and (b) providing the client with targeted advertisement based on user's profiles whereby an Advertisement Segment is created.

2. The method of claim 1, wherein server is implemented by entities comprising Internet search engine service providers, Internet advertisement systems, Internet media advertisers, Non-internet search engine service providers, advertisement systems, and media advertisers.

3. The method of claim 1, wherein client is implemented by entities comprising internet users, satellite users, media users, university users, corporate users, interactive TV users, internet protocol (IP) TV users, and governmental users.

4. The method of claim 1, wherein said Advertisement Segment is selected from a group consisting: (a) Video Clip, (b) Static pictures, (c) Dynamic Pictures, (d) Rolling pictures, (e) Scrolling pictures, (f) Banners, (g) Collection of pixels, (h) Static or Dynamic Texts, (i) Audio Visual Media, and (j) any combination of (a) to (i) above.

5. The method of claim 4 wherein said Advertisement Segment may include at least one of the following: (a) embedded hyperlink, (b) dedicated display area, (c) color, and (d) background.

6. The method of claim 1 wherein said Sponsor Links is selected from a group consisting of (a) Text, (b) Collection of symbols, (c) Advertisement Segment, and (d) Any combination of (a) to (c) above.

7. The method of claim 6 wherein said Sponsor Links may include at least one of the following: (a) embedded hyperlink, (b) dedicated display area, (c) color, and (d) background.

8. The method of claim 1 wherein the Sponsor Links and Advertisement Segments are located within a common web browser screen.

9. The method of claim 1 wherein the Sponsor Links and Advertisement Segment are located within an interactive TV screen.

10. The method of claim 1 wherein the user profile is constructed from data which is provided by the user whereby a direct user's data is created.

11. The method of claim 10 wherein the user provides data such as age, gender, and zip-code.

12. The method of claim 11 wherein the user is compensated either by payment or discount in exchange for providing the data.

13. The method of claim 12 wherein said payment is conducted via credit card for (a) Verification of the user data, (b) Collection of user data, (c) Optional payment as part of the user compensation, and (d) Fraud prevention.

14. The method of claim 1 wherein the user profile is constructed from data which is not provided by the user whereby an indirect user's data is created.

15. The method of claim 14 wherein indirect user's data such as zip-code is retrieved from data located in the user's computer.

16. The method of claim 14 wherein indirect user's data is retrieved from data saved under common browser fields such as “local weather” field, “local” tab, “cookies”, and bookmarks.

17. The method of claim 14 wherein indirect user's data is obtained from the user's Organization of Choice's data.

18. The method of claim 17 wherein the Organization of Choice is an organization comprising medical and health related organization, religious related organization, school and academic organization, sport organization, research organization, non profit organization, relief organization, service related organization, safety related organization, philanthropic foundation and organization, and social organization.

19. The method of claim 17 wherein Organization of Choice's data is associated with a user profile.

20. The method of claim 17 wherein the Organization of Choice's data is processed to improve, update and enrich the user profile.

21. The method of claim 1 wherein public, private, and proprietary data is used together with direct or indirect user's data as part of the process which creates a user profile.

22. The method of claim 21 wherein public, private and proprietary data is searched and processed periodically to improve, update, and enrich the user profile.

23. The method of claim 1 wherein a user profile is used to create a unique targeted Sponsor Link associated with the user profile.

24. The method of claim 1 wherein a user profile is used to create a unique targeted Advertisement Segment associated with the user profile.

25. The method of claim 1 wherein the user profile is enriched and adjusted based on statistical and mathematical processes, algorithm and formulas.

26. The method of claim 3 wherein two different users with two different user profiles obtain two different Sponsor Links sets as a result of using the same search topic at the same time with the same search engine.

27. The method of claim 3 wherein two different users with two different user profiles obtain two different Advertisement Segments as a result of using the same search topic at the same time with the same search engine.

28. The method of claim 3 wherein two different users with two different user profiles obtain two different Advertisement Segments while surfing the Internet at the same time and under the same URL page.

29. The method of claim 18 wherein the Organization of Choice registers itself under the search engine provider or advertiser database.

30. The method of claim 29 wherein the Organization of Choice obtains an ID (“organization ID”) as part of the registration process.

31. The method of claims 18 wherein the Organization of Choice adds a software code to its URL page. This code:
a. Links between the Organization of Choice URL and the search engine provider.
b. Transmits the organization ID to the search engine provider and/or advertiser.

32. The method of claim 18 wherein the user selects the Organization of Choice by using its URL as the user's default search engine.

33. The method of claims 18 wherein the user selects the Organization of Choice from a list of registered organizations.

34. The method of claim 2 wherein the search engine provider and/or advertiser donates money to the user's Organizations of Choice.

35. The method of claim 34 wherein a user needs to provide data which is specified by the search engine provider and/or advertiser, in exchange of a donation to the Organization of Choice.

36. The method of claim 32, 33 or 34 wherein the donation to an Organization of Choice is enabled:
a. As a result of the user's clicks on one of the targeted Sponsor Links hyperlink AND
b. The Organization ID is sent to the search engine provider via the software code embedded in the Organization of Choice URL or the user selection of Organization of Choice.

37. The method of claim 32, 33 or 34 wherein the donation to an Organization of Choice is enabled:
a. As a result of the user's clicks on Advertisement Segment
AND
b. The Organization ID is sent to the advertiser via the software code embedded in the Organization of Choice URL or the user selection of Organization of Choice.

38. The method of claim 18 wherein the Organization of Choice provides a Group-ID:
a. The Group-ID is a unique key.
b. The Group-ID is used to better classify, improve, update and enrich the user profile.
c. The Group-ID classified sub-groups inside a group.

39. The method of claim 38 wherein the search engine provider and/or advertiser may donates different amounts of money to an Organization of Choice which provides its users with Group-ID, compared to an Organization of Choice which does not.

40. The method of claim 1 wherein a unique ID (Identification Number) is attached to the user (“user ID”) who searches and/or surf the Internet.

41. The method of claim 40 wherein the process of generating the user ID uses one or a combination of:
a. Computer IP address
b. Computer Login data (e.g. Password, Login Name)
c. URL login data
d. Computer Hardware ID data
e. Browser version/ID
f. City
g. State
h. Country of origin
i. Internet service provider
j. Computer operating system

42. The method of claim 1 wherein a unique ID (Identification Number) is attached to the user profile (“profile ID”).

43. The method of claim 40 wherein the user ID is sent to the search engine provider and/or advertiser as a result of a click on a hyperlink associated with the Sponsor Links and/or Advertisement Segments.

44. The method of claim 43 wherein the user ID is being tracked over a period of time.

45. The method of claim 44 wherein multiple identical clicks from a user ID are ignored if sent within a specified time frame.

46. The method of claim 44 wherein a counter and timer are used to recognize multiple identical clicks on the same hyperlink.

47. The method of claim 45 wherein a donation to an Organization of Choice of a specific user is canceled if multiple identical clicks from a user ID are recognized.

48. The method of claim 2 wherein the advertiser can select one or more user profiles to which his Advertisement Segment and/or Sponsor Link will be displayed.

49. The method of claim 1 wherein one or more user profiles are being tested against the number of clicks per specific hyperlink to determine the effectiveness of the target marketing parameters.

50. The method of claim 11 wherein the user's age is being tracked and updated automatically by the user profile database software program.

51. The method of claim 50 wherein the user profile is adjusted, improved and enriched periodically based on user age and statistical analysis.

52. The method of claim 3 wherein multiple users who use the same computer have a different user ID.

53. The method of claim 3 wherein multiple users who use the same computer have different profile ID.

54. The method of claim 52 wherein a login process is used to differentiate between two or more users who use the same computer.

55. The method of claim 53 wherein a Group-ID is used to differentiate between two or more profiles ID who use the same computer.

56. The method of claim 1 wherein Sponsor Links are created as a result of Internet search activity.

57. The method of claim 1 wherein Advertisement Segments are created as a result of Internet surfing activity.

58. The method of claim 1 wherein Advertisement Segments are created as a result of running an Internet related program or software code.

59. The method of claim 3 wherein the interactive TV is interchanged with the Internet.

60. The method of claim 3 wherein IP TV is interchanged with the Internet.
